(19) United States
(12) Patent Application Publication
(10) Pub. No.: US 2002/0101598 A1
(43) Pub. Date: Aug. 1, 2002

(54) Printer output calibration system

(76) Inventors: Helmer Swenholt, FAlls Church, VA (US); Robin P. Swenholt, Annandale, VA (US); Gregory Drauch, Alexandria, VA (US)

Correspondence Address: DONALD J LECHER, PC, 2111 WILSON BLVD, SUITE 700, ARLINGTON, VA, 22201, US

(21) Appl. No.: 09/774,081

(22) Filed: Jan. 31, 2001

(51) Int. Cl. G06F 15/00; G06K 1/00

(52) U.S. Cl. 358/1.9

(57) ABSTRACT

A printer output calibration system for calibrating various types of printer output to standardized forms. A preprinted calibration sheet having a calibration target where a user causes a computer program to print a calibration mark onto the calibration target. A location is identified where the printed calibration mark lies relative to the calibration target. The calibration target has scaled codes along its sides that allow the user to determine the relative location of the calibration mark on the calibration target. The user then enters the codes into the computer program which takes into account the dimensions of the calibration target relative to the entered codes to calculate a vertical and/or horizontal printer offset which it applies thereafter to the printer output.

### BACKGROUND OF THE INVENTION

1. Field of Invention

The present invention pertains to the field of art encompassing the calibration of various kinds of printing devices to print to standardized forms with a high degree precision.

2. General Background and Discussion of Prior Art

Many types of software printing programs enable users to print out complex graphical printouts on standardized forms. However, in order to properly align the print output from a printer to standardized forms, users have to print their data to a blank form, determine what amount the print out needs to be adjusted by physically measuring the vertical and horizontal discrepancies, and then enter some type of offset adjustment into the computer program. Once the adjustment is entered, the program then adjusts the coordinates of the printout. If the resulting output still is not satisfactory, the user then repeats the mentioned steps of measuring the horizontal and vertical offsets and enters the new numbers into the computer program until the alignment is correct. The variety of desktop and portable printers and software programs causes each printer to output its data differently, and rarely do two identical model printers print at the exact same coordinates. This fact limits the applications of precise printing in favor of offset printing rather than desktop or portable printers.

3. Objects and Advantages

It is the principle object of the present invention is to provide a printer output calibration system that provides the user in one step with the exact data necessary to calibrate to a corresponding printing program.

It is a further object of the present invention is to provide a printer output calibration system that allows very precise positioning of printer output onto standardized print media.

It is a further object of the present invention is to provide a calibration system that calibrate any type of printer to print to standardized print media.

### SUMMARY OF THE PRESENT INVENTION

The herein disclosed and claimed system is for calibrating various types of printers' output to standardized forms by providing a preprinted calibration sheet having a calibration target thereon. The user causes a computer program to print a calibration mark onto the calibration target and then determines where the printed calibration mark lies relative to the calibration target. The calibration target has scaled codes along its sides which allow the user to determine the relative location of the calibration mark on the calibration target. The user then enters the codes into the computer program which takes into account the dimensions of the calibration target relative to the entered codes to calculate a vertical and/or horizontal printer offset which it thereafter applies to the generated print output.

### BRIEF DESCRIPTION OF THE DRAWINGS

FIG. 1 Represents one embodiment of a printable calibration form.

FIG. 2 Represents an enlarged version of a two coordinate calibration target.

FIG. 3 Represents an enlarged version of a two coordinate calibration target with calibration marks superimposed thereon.

### DETAILED DESCRIPTION OF THE PREFERRED EMBODIMENT

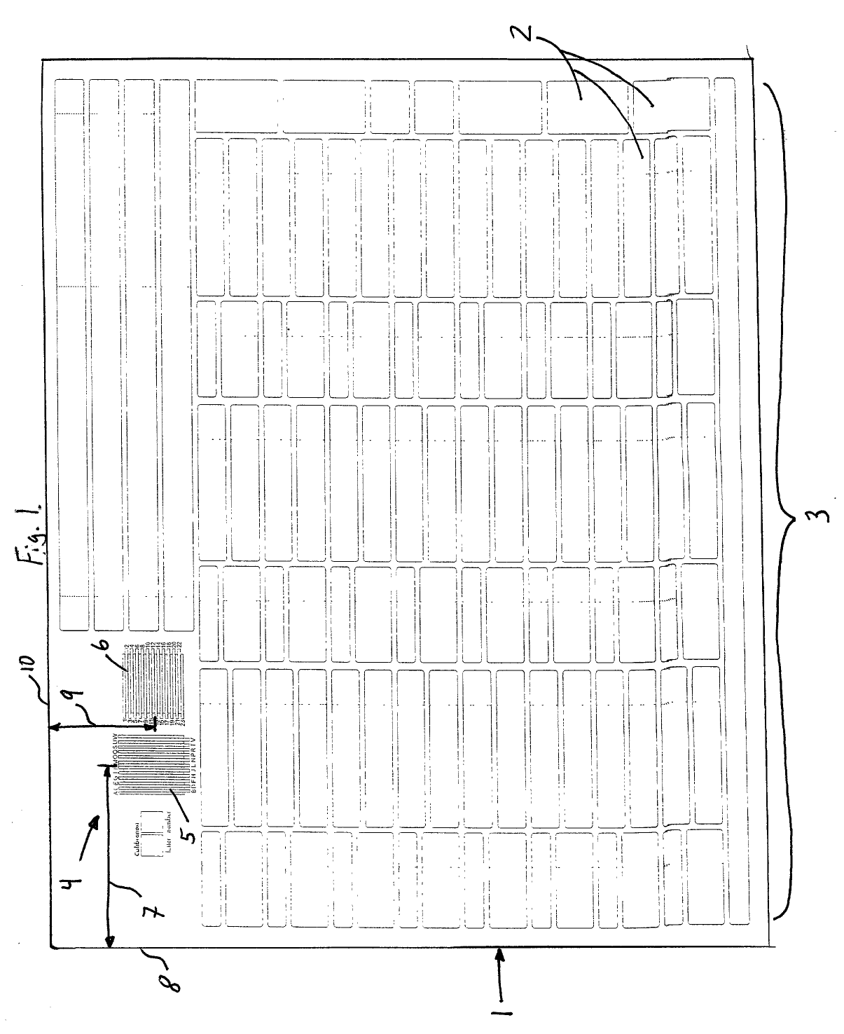

FIG. 1 shows an embodiment of a printable calibration form (1). The calibration form is used to set up a printing device wherein a user will be printing a corresponding standardized form on. The in instant embodiment, the printable calibration form (1) has a series of data fields, i.e., rectangular boxes (2) that represent labels on a standardized form that will be printed after the print device is calibrated. These boxes (2) could also take any shape and may not be labels but could be data fields where information is to be printed but not removed, as with the labels. The area occupied by the data fields generally represents the general printing area (3) for the standardized forms. These fields must be precisely oriented on the standardized print forms and the representation of the fields on the calibration form (1) to ensure that there is uniform consistency with any type of printer's output.

In the upper left hand corner of the calibration form (1) is an area outside of the general printing area (3) that contains a calibration target (4) comprises vertically (5) and horizontally (6) disposed grids. The calibration target is shown enlarged in FIG. 2. Both grids comprise of a series of markings or narrow rectangular strips of equal width, alternating between shaded and unshaded. Each of the strips has either a numeric or an alpha-numberic sequential scale on either side, wherein each letter or number designates a single marking strip.

The horizontally disposed grid (5) is used to measure the distance needed to compensate the print output in the horizontal direction. The vertical center of the horizontally disposed grid (5) is represented by the vertical “L” marking strip. This marking strip is positioned a fixed horizontal distance (7) from the left boarder (8) of the calibration form (1). In like manner, vertically disposed grid (6) is used to measure the distance needed to compensate the print output in the vertical direction. The horizontal center of the vertically disposed grid (6) is represented by the horizontal “12” marking strip. This marking strip is positioned a fixed vertical distance (9) from the top boarder (10) of the calibration form (1).

To calibrate the standardized forms to the user's printer, the user inserts the calibration sheet (1) into his printing device and generates via the printing device or a computer controlling the printing device, a calibration marks. These calibration marks are output by the printer such that the printer's signal causes the calibration mark to print at the printer's coordinates equivalent to the vertical center of the horizontally disposed grid (5) and the horizontal center of the vertically disposed grid (6). However, as mentioned above, due to the nature of paper handling, software print control code, and the physical design of desktop and portable printers, rarely will the calibration mark print at the same horizontal distance, (the “L” in the vertically disposed grid (5)), and at the same vertical distance, (the “12” in the horizontally disposed grid (6)).

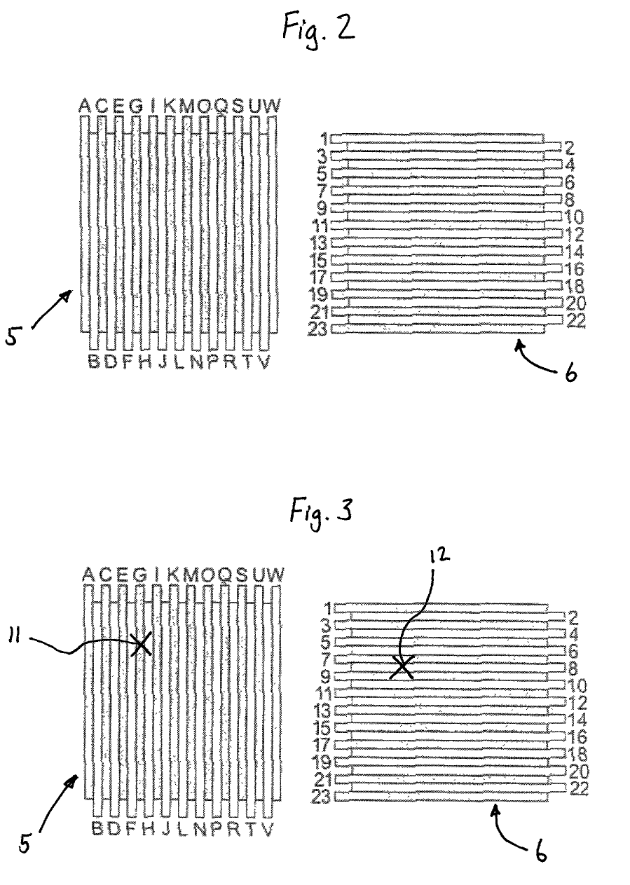

FIG. 3 shows the calibration target with two calibration marks (11 & 12) located therein. The calibration mark (11) in the vertically disposed grid (5) happens to lie on the “G” marker strip. Since “L” was the center, the printer needs to be adjusted to horizontally shift to the right the distance between “G” and “L”. The user only needs to enter the letter “G” into the print program which automatically calculates the horizontal print offset. The program will be preinformed of the width of each marker strip that it may calculate the proper offset. The embodiment shown in FIG. 1 has each marker strip width being 0.030 of an inch. For example, the computer would determine that the print output would need to be moved horizontally to the right five increments (“G”−“L”) of 0.030 inches, or 0.150 inches to the right. Likewise, the calibration mark (12) in the horizontally disposed grid (6) happens to lie on the “8” marker strip. The computer would determine that the print output would need to be moved vertically downward four increments (“12−8”) of 0.030 inches, or 0.120 inches downward.

Because many varying and different embodiments may be made within the scope of the inventive concept herein taught, and because many modifications may be made in the embodiments herein detailed in accordance with the descriptive requirement of the law, it is to be understood that the details herein are to be interpreted as illustrative and not in a limiting sense.

What is claimed as the invention is:

1. A method for calibrating printer output to a printable form, including:
generating a printable calibration form including a calibration target, wherein said printable calibration form represents said printable form;
printing a calibration mark from a print source onto said calibration form;
determining the location of said calibration mark relative to said calibration target; and
adjusting said print source output location based on said location of said at least one calibration mark relative to said calibration target.

2. A method for calibrating output to a standardized form print medium, including:
generating a calibration form comprising:
a) a representative printing area; and
b) an area outside of said representative printing area;
generating a calibration target at a first specific coordinate relative to said calibration form and outside of said representative printing area;
generating at an output device a calibration mark at a second specific coordinate relative to said output device;
outputting at said output device said at least one calibration mark at said second specific coordinate onto said calibration target;
determining the location of said outputted calibration mark relative to said calibration target; and
adjusting said output device in accordance with said step of determining.

3. The method of claim 2, wherein said step of adjusting further comprises:
adjusting the physical location of output at said output device based on said step of determining.

4. The method of claim 2, wherein said step of determining further comprises:
measuring the distance between said calibration mark and said first specific coordinate of said calibration target.

5. A method of calibrating a computer generated print output to a print medium, comprising:
providing a printable calibration medium including a calibration target located at a first set specific coordinates relative to said printable calibration medium;
generating, via a computer, a calibration mark located at a second set of specific output coordinates relative to an output device;
printing said calibration mark at said second set of specific output coordinates relative to said output device onto said printable calibration medium;
determining the location of said printed calibration mark relative to said first set of specific coordinates of said calibration target;
inputting, to said computer, data representing said location of said printed calibration mark relative to said first set of specific coordinates of said calibration target; and
adjusting the output coordinates of subsequent printing relative to said output device based on said data.

6. A printed calibration target comprising:
a locus at predetermined vertical and horizontal coordinates on a printable medium;
printed markers incrementally surrounding said locus; and
a printed scale identifying each of said printed markers;
wherein when a calibration mark is printed on said calibration target, said printed scale easily allows for identification of where said calibration mark lies amidst said calibration target markers.

7. The invention of claim 6, further comprises:
a second calibration target comprising:
a second locus at predetermined vertical and horizontal coordinates on said printable medium;
second printed markers incrementally surrounding said second locus, wherein said second printed markers are orthogonal to said first printed markers; and
a printed scale identifying each of said second printed markers;
wherein when a second calibration mark is printed on said second calibration target, said second printed scale easily allows for identification of where said second calibration mark lies amidst said second calibration target markers.
